(19) United States
(12) Patent Application Publication
(10) Pub. No.: US 2010/0248386 A1
(43) Pub. Date: Sep. 30, 2010

(54) SEMICONDUCTOR PHOSPHOR NANOPARTICLE ASSEMBLY, PRODUCING METHOD THEREOF AND SINGLE MOLECULE OBSERVATION METHOD BY USE THEREOF

(75) Inventors: Kazuyoshi Goan, Kanagawa (JP); Kazuya Tsukada, Kanagawa (JP)

Correspondence Address: CANTOR COLBURN, LLP, 20 Church Street, 22nd Floor, Hartford, CT, 06103, US

(73) Assignee: KONICA MINOLTA MEDICAL & GRAPHIC, INC., Tokyo (JP)

(21) Appl. No.: 12/675,164

(22) PCT Filed: Aug. 21, 2008
(86) PCT No.: PCT/JP2008/064896

§ 371 Date: Feb. 25, 2010

(30) Foreign Application Priority Data
Aug. 29, 2007 (JP) 2007-222209

(51) Int. Cl. G01N 21/76; C09K 11/08

(52) U.S. Cl. 436/172; 252/301.4 F

(57) ABSTRACT

The present invention provide a semiconductor phosphor nanoparticle assembly which exhibits no variation in emission wavelength and emission intensity for every particle and is capable of achieving stable evaluation when performing a single molecule observation by using an assembly of semiconductor phosphor nanoparticles as a fluorescence labeling agent, a production method thereof and a single molecule observation method by use thereof. The production method of the semiconductor phosphor nanoparticle assembly, which is performed by a liquid phase process or a gas phase process, comprises the steps of forming nuclear particles and allowing the nuclear particles to grow or fuse, wherein a concentration by number of the formed nuclear particles is not more than a specific concentration.

### TECHNICAL FIELD

The present invention relates to an assembly of semiconductor phosphor nanoparticles and a producing method thereof, and a single molecule observation method by use of the assembly of semiconductor phosphor nanoparticles.

### TECHNICAL BACKGROUND

Recently, enhancement of sensitivity of detection equipment and materials, and enhanced luminance of labeling materials have enabled detection of a single molecule, its identification and observation of its motion, playing an important role in analytical chemistry, molecular biology and analysis of a nano-structure material.

There was proposed a fluorescent dye or a nanoparticle phosphor as a labeling material used for observation of a single molecule. Specifically, compared to a fluorescent dye, a nanoparticulate phosphor exhibits many advantages such that an appropriate selection of size or material quality enables setting an emission peak wavelength rather freely in the range of 400 to 2000 nm, a broad Stokes shift can be achieved, reduction of overlapping with an exciting light or a noise effect of the background can achieve enhanced detection capability and markedly reduced fading enables dynamic observation over a long period of time.

A substance which is composed of a nanometer-sized semiconductor material and exhibits a quantum confinement effect is generally called a quantum dot. Such a quantum dot, which is a small agglomerate of some ten nms and composed of some hundreds to some thousands of semiconductor atoms, emits an energy equivalent to the energy band gap of the quantum dot when absorbing light from an exciting source and reaching an energy-excited state. Therefore, it is considered that controlling the size or material composition of a quantum dot can adjust the energy band gap, enabling to employ an energy of a wavelength band at various levels.

However, a quantum dot has a crystal structure exhibiting a property such that the band gap is variable with particle size, and since an emission wavelength varied with variation of the band gap, variation in particle size from particle to particle leads to variation in the emission spectrum. Accordingly, there are problems in principle such that to avoid the foregoing variation, there is needed a complicated operation to classify particles to ones exhibiting a single spectrum.

Further, a nanoparticle phosphor assembly employed in practice exhibits a particle size distribution and the individual particles vary in emission spectrum or luminance, producing problems such that stable evaluation cannot be achieved when conducting a single molecule observation.

It is considered that, to obtain a monodisperse nanoparticle phosphor assembly of a narrow particle size distribution, it be necessary to form appropriate nuclear particles to perform production through a bottom-up system (approach), while controlling the reaction of the individual atoms.

However, for example, in the case of forming nanoparticles through a reversed micelle reaction method, the size or state of reversed micelles forming a reaction field varies depending on the concentration or kind of a surfactant, producing problems that the conditions to form nanoparticles are restricted. Further, patent documents of the prior art describe in detail with respect to the growth stage after nuclear formation but there is no detailed description with respect to the state of nuclear particles as its base and there has not been achieved detailed clarification thereof (as set forth in, for example, patent documents 1-3).

Patent document 1: JP 2000-322472A

Patent document 2: JP 2005-236080A

Patent document 3: JP 2006-62882A

### DISCLOSURE OF THE INVENTION

### Problem to be Solved

The present invention has come into being in view of the foregoing problems and circumstances and a problem to be solved is to provide a semiconductor phosphor nanoparticle assembly which exhibits no variation in emission wavelength and emission intensity for every particle and is capable of achieving stable evaluation when performing a single molecule observation by using an assembly of semiconductor phosphor nanoparticles as a fluorescence labeling agent; a production method of the same and a single molecule observation method by use of the same.

### Means for Solving the Problems

As a result of extensive study by the inventors of this application to solve the foregoing problems with focusing on concentration at the time when forming nuclear particles, it was found that controlling a nuclear particle formation concentration by number resulted in formation of monodisperse nanoparticles exhibiting a highly enhanced luminance, whereby the invention was achieved.

The foregoing problems related to the invention was solved by the following constitution.

1. A method of producing an assembly of semiconductor phosphor nanoparticles by a liquid phase process, the method comprising the steps of forming nuclear particles and allowing the nuclear particle to grow or fuse, wherein a concentration by number of nuclear particles formed per m³ of a reaction solution is from 1.0×10²⁵ to 5.0×10²⁶ particles.

2. A method of producing an assembly of semiconductor phosphor nanoparticles by a gas phase process, the method comprising the steps of forming nuclear particles and allowing the nuclear particles to grow or fuse, wherein a concentration by number of nuclear particles formed per m³ of a film of the assembly of semiconductor phosphor nanoparticles is from 1.0×10¹⁵ to 1×10¹⁶ particles.

3. An assembly of semiconductor phosphor nanoparticles obtained by the method of producing an assembly of semiconductor phosphor nanoparticles, as described in the foregoing 1 or 2.

4. The assembly of semiconductor phosphor nanoparticles, as described in the foregoing 3, wherein an average particle size of the semiconductor phosphor nanoparticles is from 1 to 10 nm.

5. The assembly of semiconductor phosphor nanoparticles, as described in the foregoing 3 or 4, wherein the semiconductor phosphor nanoparticles comprise a component of Si or Ge.

6. A single molecule observation method comprising exposing a molecule labeled with a semiconductor nanoparticle phosphor constituting an assembly of semiconductor phosphor nanoparticles, as described in any of the foregoing 3. to 5. to exciting light and detecting an emitted light to perform identification of the molecule.

7. The single molecule observation method, as described in the foregoing 6, wherein the method comprises labeling plural kinds of molecules with semiconductor nanoparticle phosphors exhibiting different emission spectra, and exposing the molecules to exciting light to perform simultaneous identification of plural kinds of substances.

### EFFECT OF THE INVENTION

According to the foregoing means is provided a semiconductor phosphor nanoparticle assembly which exhibits no variation in emission wavelength and emission intensity for every particle and is capable of achieving stable evaluation when performing a single molecule observation by using an assembly of semiconductor phosphor nanoparticles as a fluorescence labeling agent; a production method of the same and a single molecule observation method by use of the same.

### PREFERRED EMBODIMENTS OF THE INVENTION

In the invention, a producing method of a semiconductor phosphor nanoparticle assembly comprises the step of forming nuclear particles by a liquid phase process or a gas phase process and a step of growing or fusing the nuclear particles and is featured in that the concentration by number of the formed nuclear particles is within a range as described above. This feature is a characteristic in common with the foregoing 1-7.

The production method of the invention is suitable for a method of producing an assembly of semiconductor phosphor nanoparticles having an average particle size of 1 to 10 nm and is specifically suitable for a method of producing an assembly of semiconductor phosphor nanoparticles containing Si or Ge.

Further, a semiconductor nanoparticle phosphor is applicable to a single molecule observation method in which a molecule labeled with the semiconductor nanoparticle phosphor is exposed to exciting light and the emitted light is detected, whereby the molecule is identified. Specifically, it is applicable to a single molecule observation method in which plural kinds of molecules are labeled with semiconductor nanoparticle phosphors exhibiting different emission spectra and exposed to exciting light to perform simultaneous identification of plural kinds of substances.

In the invention, the semiconductor phosphor nanoparticle assembly refers to a dispersion (including a solution and a suspension) containing semiconductor phosphor nanoparticles, a powder comprised of semiconductor phosphor nanoparticles, a sheet carrying a dispersion in which semiconductor phosphor nanoparticles are dispersed, or the like.

In the following, there will be further described the present invention and its constituent elements, and preferred embodiments of the invention.

### Material to Form Semiconductor Nanoparticle Phosphor

A semiconductor nanoparticle phospho related to the invention can be formed by use of a variety of semiconductor materials.

Preferred examples of a II-VI group semiconductor include MgS, MgSe, MgTe, CaS, CaSe, CaTe, SrS, SrSe, SrTe, BaS, BaSe, BaTe, ZnS, ZnSe, ZnTe, CdS, CdSe, HgS, HgSe and HgTe.

Preferred examples of a III-V group semiconductor include GaAs, GaN, GaP, GaSb, InGaAs, InP, InN, InSb, InAs, AlAs, AlP, AlSb and AlS.

Of IV group semiconductors, Ge, Pb and Si are specifically suitable.

In the present invention, preferably, semiconductor phosphor nanoparticles have a core/shell structure. In such a case, it is preferred that semiconductor phosphor nanoparticles are those which have a core/shell structure constituted of a core particle of a semiconductor particle and a shell layer covering the core particle, and that the core particle differs in chemical composition from the shell layer.

### Core Particle

Semiconductor materials used for core particles may employ a various kinds of semiconductor materials. Specific examples thereof include MgS, MgSe, MgTe, CaS, CaSe, CaTe, SrS, SrSe, SrTe, BaS, BaTe, ZnS, ZnSe, ZnTe, CdS, CdSe, CdTe, GaAs, GaP, GaSb, InGaAs, InP, InN, InSb, InAs, AlAs, AlP, AlSb, AlS, PbS, PbSe, Ge, Si and a mixture of these. In the present invention, a specifically preferred semiconductor material is Si or Ge. A dope material such as Ga may optionally be contained in a trace amount.

Semiconductor materials used for a shell may employ various kinds of semiconductor materials. Specific examples thererof include SiO₂, ZnO, ZnS, ZnSe, ZnTe, CdO, CdS, CdSe, CsTe, MgS, MgSe, GaS, GaN, GaP, GaAs, GaSb, InAs, InN, InP, InSb, AlAs, AlN, AlP, AlSb and further mixtures of these. In the present invention, a specifically preferred semiconductor material is SiO₂ or ZnS. The shell layer related to the invention need not completely cover all of the surface of a core particle unless partial exposure of the core particle has an adverse effect.

It has been known in the art that reduction of a core particle size to a nano-size results in a quantum size effect, formation of a core/shell structure leads to an increased band gap energy, rendering it feasible to derive desirable characteristics. For instance, when the surface of a light-emissive nanoparticle is exposed, a large number of defects existing on the light-emissive nanoparticle surface become an emission killer, leading to a lowering of the emission efficiency. Accordingly, coverage with a shell material having a band gap greater than that corresponding to the emission wavelength of a nanoparticle can enhance its emission intensity. Such an advantage is specifically effective in an assembly of semiconductor phosphor nanoparticles, obtained by the production method of the invention.

The average particle size of semiconductor phosphor nanoparticles relating to the invention is preferably from 1 to 10 nm. In the form of a core/shell structure, the average core particle size is preferably from 1 to 10 nm, and the average shell thickness is preferably from 0.2 to 0.6 nm.

In the invention, the average particle size of semiconductor phosphor nanoparticles needs to be determined three-dimensionally but it is difficult to determine the particle size in such a manner because of being extremely minute. Actually, it has to be determined in a two-dimensional image, so that it is preferred to determine an average size in such a manner that electronmicrographs are taken using a transmission electron microscope (TEM) to perform averaging. Thus, electronmicrographs are taken using a TEM and a sufficient number of particles are measured with respect to cross-sectional area to determine the diameter of a circle, equivalent to the cross-sectional area and an arithmetic average thereof is defined as the average particle size. The number of particles to be photographed by a TEM is preferably at least 100 particles, and more preferably at least 1,000 particles. In the invention, an arithmetic average of 1,000 particles is defined as the average particle size.

### Production Method of Semiconductor Phosphor Nanoparticle Assembly

In the invention, a production method of a semiconductor phosphor nanoparticle assembly comprises the step of forming nuclear particles by a liquid phase process or a gas phase process and the step of allowing to grow or fuse the nuclear particles, in which the concentration by number of the formed nuclear particles is within the range described below.

Namely, in cases when forming nuclear particles by a liquid phase process, the concentration by number of formed nuclear particles needs to be adjusted to fall within the range of 1×10²⁵ to 5.0×10²⁶ particles formed per m³ of reaction solution. The concentration by number of formed nuclear particles can be adjusted by controlling the addition amount or the addition rate of a raw material of the nuclear particles, reaction temperature, liquid physical property, or the like.

Meanwhile, in cases when forming nuclear particles by a gas phase process, the concentration by number of formed nuclear particles needs to be adjusted to fall within the range of 1×10¹⁵ to 1.0×10¹⁶ particles formed per 1 m³ of a layer of the semiconductor phosphor nanoparticle assembly. The concentration by number of formed nuclear particles can be adjusted by controlling, for example, in the case of the sputtering method, the distance between the target and the substrate, the vacuum degree within the chamber, or the like.

In the gas phase process or the liquid phase process, when the concentration by number of nuclear particles formed therein is less than in the foregoing range, the frequency of particles grown to a particle size sufficient for emission is relatively small, resulting in an assembly exhibiting an increased variation in emission and a reduced phosphorescence quantum yield. On the other hand, when the concentration by number of nuclear particles formed therein is greater than the foregoing range, variation in growth increases and the particle size distribution is broadened, resulting in increased variation in crystallinity and an increased distribution of emission wavelength and emission intensity.

Production methods by a liquid phase process include, for example, a coprecipitation method, a sol-gel method, a homogeneous precipitation method and a reduction method. There are further included methods superior in production of nanoparticles, such as a reverse micelle method and a supercritical hydrothermal synthesis method (as described in, for example, JP 2002-322468A, JP 2005-239775A, JP 10-310770A, and JP 2000-104058A).

A producing method of an assembly of semiconductor phosphor nanoparticles is preferably a method comprising a step of reducing a semiconductor material precursor through reduction reaction. Further, in one preferred embodiment of the invention, the reaction of such a semiconductor material precursor is performed in the presence of a surfactant. A semiconductor material precursor related to the invention is a compound containing an element used for the above-described semiconductor material and, for example, in the case of the semiconductor material being Si, SiCl₄ is cited as a semiconductor material precursor. Other examples of a semiconductor material include InCl₃, P(SiMe₃)₃, ZnMe₂, CdMe₂, GeCl₄ and tributylphosphine selenium.

The reaction temperature is not specifically limited if it is not less than the boiling point of the semiconductor material precursor and not more than the boiling point of the solvent, but is preferably in the range of 70 to 110° C.

### Reducing Agent

A reducing agent used for reduction of a semiconductor material precursor can be chosen from a variety of reducing agents known in the art, in accordance with reaction conditions. In the invention, reducing agents such as lithium aluminum hydride (LiAlH₄), sodium borohydride (NaBH₄), sodium aluminum bis(2-methoxyethoxy)hydride, lithium tri(sec-butyl)borohydride [LiBH(sec-C₄H₉)₃], potassium tri(sec-butyl)borohydride and lithium triethylborohydride are preferred in terms of reducing strength. Of these, lithium aluminum hydride (LiAlH₄) is specifically preferred in terms of reducing strength.

### Solvent

A variety of solvents known in the art are usable as a solvent to disperse a semiconductor material precursor. Preferred examples thereof include alcohols such as ethyl alcohol, sec-butyl alcohol and t-butyl alcohol; and hydrocarbon solvents such as toluene, decane and hexane. A hydrophobic solvent such as toluene is specifically preferred as a solvent for use in these dispersion.

### Surfactant

There are usable a variety of surfactants known in the art in the invention, including anionic, non-ionic, cationic, and amphoteric surfactants. Of these are preferred quaternary ammonium salts, such as tetrabutylammonium chloride, bromide, or hexafluorophosphate; tetraoctylammonium bromide (TOAB), and tributylhexadecylphosphonium bromide.

A reaction by a liquid phase process is greatly variable according to the state of a compound in liquid including a solvent. There is required attention specifically when producing nano-sized particles superior in mono-dispersibility. In a reverse micelle method, for example, the size or state of reversed micelles which forms a reaction field is varied by the concentration or kind of a surfactant used therein, so that the condition to form nanoparticles is restricted. Accordingly, an appropriate surfactant is required to be combined with a solvent.

Production methods by a gas phase process include (1) a method in which a raw material semiconductor is evaporated by a first high temperature plasma generated between opposed electrodes and allowed to pass through a second high temperature plasma generated through electrodeless discharge in a reduced pressure environment (as described in, for example, JP 6-279015A), (2) a method in which nanoparticles are separated from an anode composed of a raw semiconductor material through electrochemical etching (described in, for example, JP 2003-515459A, (3) a laser ablation method (described in, for example, JP 2004-356163A), and (4) a high-speed sputtering method (described in, for example, JP 2004-296781A). There is also preferably employed a method in which a raw material gas is subjected to a gas phase reaction in a low pressure state to synthesize a powder containing particles.

### Application Example

The semiconductor phosphor nanoparticles according to the invention is applicable to single molecule analysis in various technical fields. In the foregoing single molecule observation method, for instance, plural kinds of molecules are labeled with plural kinds of nanoparticulate semiconductor phosphors and exposure of the molecules to exciting light makes it feasible to perform simultaneous identification of such plural kinds of molecules. Structural isomers which are identical in chemical composition but different in chemical structure are also included as applicable plural kinds of molecules.

Typical application examples are described below.

### Biomaterial Labeling Agent and Bio-Imaging

The semiconductor phosphor nanoparticle assembly according to the invention is applicable to a fluorescent labeling agent for biomaterials. To a living cell or living body having a targeted (or traced) material is added a fluorescent labeling agent according to the invention and is bound or adsorbed onto the targeted material; such a bound or adsorbed material is exposed to an exciting light of a prescribed wavelength and a fluorescence with a specific wavelength which is emitted from semiconductor phosphor particles, is detected to perform fluorescent dynamic imaging of the targeted (or traced) material. Thus, a biomaterial labeling agent related to the invention can be employed for a bio-imaging method (technical means to visualize a bio-molecule constituting a biomaterial or its dynamic phenomenon).

### Hydrophilization of Semiconductor Phosphor Nanoparticle Assembly

The particle surface of the foregoing semiconductor phosphor nanoparticle assembly is generally hydrophobic. For example, in cases when using as a biomaterial labeling agent, the particles are poorly dispersed in water as they are, producing problems such as coagulation. Accordingly, it is preferred to subject the shell surface of core/shell type semiconductor phosphor nanoparticles to a hydrophobilization treatment. Such a hydrophobilization treatment is conducted, for example, in such a manner that after removal of hydrophobic substances with pyridine or the like, a surface-modifier is chemically or physically bound to the particle surface. A preferred surface-modifier is one containing a carboxyl or amino group as a hydrophilic group. Specific examples of such a surface-modifier include mercaptopropionic acid, mercaptoundecanoic acid and aminopropane-thiol. Specifically, for example, 10⁻⁵ g of core/shell type Ge/GeO₂ nanoparticles are dispersed in 10 ml pure water containing 0.2 g of mercaptoundecanoic acid and stirred at 40° C. for 10 min. to subject the shell surface to a treatment, whereby the shell surfaces of the nanoparticles are modified with a carboxyl group.

### Biomaterial Labeling Agent

A biomaterial labeling agent relating to the invention is obtained by binding the thus hydrophilized semiconductor phosphor nanoparticles to a molecular-labeling substance through an organic molecule.

### Molecular-Labeling Substance

In the biomaterial labeling agent relating to the invention, a molecular-labeling substance is specifically bonded to and/or reacted with a biomaterial, whereby labeling of the biomaterial becomes feasible. Examples of a molecular-labeling substance include a nucleotide chain, antibody, an antigen and cyclodextrin.

### Organic Molecule

In the biomaterial labeling agent relating to the invention, hydrophilized semiconductor phosphor nanoparticles and a molecular-labeling substance are bound through an organic molecule. The foregoing organic molecule may be any organic compound capable of combining a nanosized semiconductor phosphor and a molecular labeling substance. Preferred examples thereof include proteins, specifically such as albumin, myoglobin and casein; and the combined use of avidin and biotin. The binding mode is not specifically limited, including a covalent bond, ionic bond, hydrogen bond, coordination bond, physical adsorption and chemical adsorption. Of these, a bonding with high bonding strength, such as a covalent bond is preferred in terms of bonding stability.

Specifically, in the case of semiconductor phosphor nanoparticles being hydrophilized with mercaptoundecanoic acid, avidin is used together with biotin. In that case, carboxyl groups of the hydrophilized nanoparticles are appropriately covalent-bonded to avidin, further, this avidin is selectively bonded to biotin and this biotin is bonded to a biomaterial labeling agent to form a biomaterial labeling agent.

### EXAMPLES

The present invention is further described with reference to examples but the invention is by no means limited to these.

### Example 1

### Preparation of Nanosized Si Phosphor by Liquid Phase Process

In 200 ml of toluene was dissolved 3 g of tetraoctylammonium bromide (TOAB). Further thereto, SiCl₄ was dropwise added in the amount shown in Table 1, while stirring at room temperature and after 1 hour, lithium aluminum hydride was further added in an amount of two times that of the SiCl₄ to perform a reduction reaction. After 3 hr., 40 ml of methanol was added thereto to deactivate an excessive reducing agent and allylamine was further added together with a platinum catalyst. Then, the solvent was removed by a rotary evaporator. After washing with methyl formamide and pure water, a sample of an assembly of Si phosphor nanoparticles dispersed in water was obtained.

### Measurement of Concentration by Number of Nuclear Particles:

In the foregoing preparation of an assembly of Si phosphor nanoparticles, immediately before adding lithium aluminum hydride, a part of the reaction solution was sampled under an argon atmosphere to determine the particle size of a reversed micelle formed of TOAB/SiCl₄ by a dynamic light scattering method. From the relationship between the obtained particle size and the addition amount, the number of reversed micelles was calculated to determine a concentration by number of the formed nuclear particles.

### Preparation of Nanosized Si Phosphor by Gas Phase Process:

Using three pieces of a Si tablet (20 mm φ) laid on SiO₂ (65 mm φ) as a target, film was formed on a fused quartz substrate by a high frequency sputtering apparatus. Sputtering was carried out under the condition of a base pressure of 2.5×10⁻⁵ Pa, an introduced argon pressure of 1 Pa and an RF output of 200 W. The distance between the target and the substrate was varied as shown in Table 2.

After subjecting these film samples to a heating treatment at 1,000° C. in an argon atmosphere, each sample was treated with hydrofluoric acid so that a SiO₂ film thickness became not more than 1 μm. A SiO₂ film was peeled off from the substrate and subjected to an ultrasonic dispersing treatment in ethanol. After being filtered, a sample of an assembly of Si phosphor nanoparticles dispersed in ethanol was obtained.

### Measurement of Concentration by Number of Nuclear Particles:

In the foregoing preparation of an assembly of Si phosphor nanoparticles, the ratio of Si/SiO₂ was measured by X-ray photoelectron spectroscopy, while cutting the surface by a laser, with respect to each of the samples obtained by sputtering under the same conditions. On the other hand, transmission electron microscopic (TEM) images of the film cross-section were photographed and not more than 1,000 particles were measured to determine the number of Si nanoparticles existing in the film as well as the Si/SiO₂ ratio, whereby the concentration by number of the formed nuclear particles was determined.

### Measurement of Particle Size Distribution:

TEM images of the obtained dispersion were photographed and not more than 1,000 particles were measured to determine the average particle size of nanoparticles in the dispersion. Measurement results are shown in Tables 1 and 2.

### Crystallinity:

Some portions of Si nanoparticle powder before being dispersed in water was sampled and Raman scattering measurement was conducted using an argon ion laser at a wavelength of 515 nm. There were observed a sharp peak attributed to crystalline silicon and a broad peak attributed to amorphous silicon. An amorphous peak intensity, which was represented by a relative value, based of a crystalline peak intensity being 1, is shown in Tables 1 and 2. A lowers value indicates higher crystallinity.

### Fluorescence Quantum Yield:

Each of the obtained 18 phosphor nanoparticle dispersion samples was exposed to exciting light at a wavelength of 350 nm, after which a fluorescence emission spectrum was measured. The quantum yield was determined from an absorption coefficient obtained from the absorption spectrum of each sample, a wave number integration value of the fluorescence emission spectrum and a refractive index of a solvent, based on sample 1.

A quantum yield (φx) of a sample is represented by the following expression (A):

φx=Fₓnₓ²/Fᵣnᵣ²·εᵣcᵣdᵣ/εₓcₓdₓ·φᵣ (A)

where Fₓ is the wave number integration value of a sample, nₓ is the refractive index of a solvent of a sample, εₓcₓdₓ is the absorbance of a sample, Fᵣ is the wave number integration value of a standard reference material, nᵣ is the a refractive index of a solvent of a standard reference material, εᵣcᵣdᵣ is the absorbance of a standard reference material and φᵣ is the quantum yield of a standard reference material.

A quantum yield is represented by a relative value, based on that of sample 1 being 1.0. The foregoing evaluation results are shown in Tables 1 and 2.

### Single Molecule Observation:

Using a scanning near field optical microscope, each dispersion was observed with respect to the emission spectrum of the individual particles when excited at a wavelength of 350 nm. Emission spectra of 100 particles were measured for each dispersion and a standard deviation of emission peak intensity was calculated. Measurement results are shown in Tables 1 and 2, together with variation width of emission peak wavelength.

In the column showing the number of formed nuclear particles in Table 1, for example, “3.0E+24” represents 3.0×10²⁴. The number of formed nuclear particles in Tables 1 and 2 are also represented similarly.

TABLE 1

| | | | | | | Standard Deviation of | | |
|---|---|---|---|---|---|---|---|---|
| | | Number of Formed | | Particle | Fluorescence | Single Molecule Observation | | |
| Sample | SiCl₄ | Nuclear Particles | | Size | Quantum | Emission | Emission Peak | |
| No. | (μL) | (particle/m³) | Crystallinity | (μm) | Yield | Intensity | Wavelength | Remark |
| 1 | 184 | 3.0E+24 | (*1) | 1.5 | 1.0 | 40 | 60 | Comp. |
| 2 | 368 | 6.0E+24 | 20 | 2.0 | 1.2 | 42 | 50 | Comp. |
| 3 | 736 | 1.2E+25 | 0.6 | 2.0 | 3.5 | 10 | 5 | Inv. |
| 4 | 1472 | 2.4E+25 | 0.2 | 2.3 | 3.8 | 10 | 5 | Inv. |
| 5 | 2944 | 4.8E+25 | 0 | 2.4 | 4.5 | 5 | 3 | Inv. |
| 6 | 5888 | 9.6E+25 | 0 | 2.6 | 5.6 | 5 | 3 | Inv. |
| 7 | 11776 | 1.9E+26 | 0 | 2.8 | 5.5 | 3 | 3 | Inv. |
| 8 | 23552 | 3.8E+26 | 0 | 3.0 | 5.0 | 4 | 3 | Inv. |
| 9 | 47104 | 7.7E+26 | (*1) | 3.5 | (*2) | — | — | Comp. |

(*1): Only amorphous peak was observed.
(*2): No emission spectrum was observed

TABLE 2

| | | | | | | Standard Deviation of | | |
|---|---|---|---|---|---|---|---|---|
| | | Number of Formed | | Particle | Fluorescence | Single Molecule Observation | | |
| Sample | Distance | Nuclear Particles | | Size | Quantum | Emission | Emission Peak | |
| No. | (cm) | (particle/m³) | Crystallinity | (μm) | Yield | Intensity | Wavelength | Remark |
| 10 | 70 | 5.0E+14 | (*1) | 2.0 | (*2) | — | — | Comp. |
| 11 | 50 | 9.8E+14 | 20 | 2.5 | 0.8 | 42 | 50 | Comp. |
| 12 | 40 | 1.5E+15 | 0.5 | 3.0 | 3.8 | 7 | 5 | Inv. |
| 13 | 35 | 2.0E+15 | 0 | 3.2 | 4.4 | 5 | 3 | Inv. |
| 14 | 30 | 2.7E+15 | 0 | 3.4 | 4.5 | 5 | 3 | Inv. |
| 15 | 25 | 3.9E+15 | 0 | 3.6 | 4.4 | 3 | 4 | Inv. |
| 16 | 20 | 6.1E+15 | 0.2 | 3.8 | 4.2 | 3 | 3 | Inv. |
| 17 | 15 | 1.1E+16 | 15 | 4.0 | 1.4 | 30 | 30 | Comp. |
| 18 | 10 | 2.5E+16 | 20 | 4.5 | 1.3 | 30 | 40 | Comp. |

(*1): Only amorphous peak was observed.
(*2): No emission spectrum was observed

As is apparent from the results shown in Tables 1 and 2, an assembly of semiconductor phosphor nanoparticles, according to the invention exhibits an enhanced fluorescence quantum yield and a smaller standard deviation of emission intensity as well as reduced variation, compared to comparative Examples. From these results, it is proved that nano-particulate semiconductor phosphor according to the invention is superior as a labeling material for single molecule observation.

### Example 2

In 0.2 g of mercaptoundecanoic acid dissolved in 10 ml pure water was dispersed 1×10⁻⁵ g of each of the assembly of semi-conductive Si phosphor nanoparticles, prepared in Example 1 and stirred at 40° C. for 10 min., whereby hydrophilized nanoparticles were obtained.

Thereafter, 25 mg of avidin was added to each of the aqueous solutions of surface-hydrophilized nanoparticles to obtain avidin-conjugated nanoparticles.

Into the obtained aqueous avidin-conjugated nanoparticle solution was added a biotinated oligonucleotide having a known base sequence to prepare a nanoparticle-labeled oligonucleotide.

It was proved that, when the foregoing labeled oligonucleotide was dropwise added onto a DNA chip onto which oligonucleotides having various base sequences were immobilized, only spots of an oligonucleotide having a complementary base sequence to the labeled oligonucleotide exhibited different color emission, depending on semiconductor phosphor nanoparticle size when exposed to ultraviolet rays.

From the foregoing result, it was proved that labeling of oligonucleotide by the nanoparticulate semiconductor phosphor relating to the invention was feasible.

1. A method of producing an assembly of semiconductor phosphor nanoparticles by a liquid phase process, the method comprising the steps of:
forming nuclear particles, and
allowing the nuclear particle to grow or fuse,
wherein a concentration by number of nuclear particles formed per m³ of a reaction solution is from 1.0×10²⁵ to 5.0×10²⁶ particles.

2. A method of producing an assembly of semiconductor phosphor nanoparticles by a gas phase process, the method comprising the steps of:
forming nuclear particles, and
allowing the nuclear particles to grow or fuse,
wherein a concentration by number of nuclear particles formed per m³ of a film of the assembly of semiconductor phosphor nanoparticles is from 1.0×10¹⁵ to 1×10¹⁶ particles.

3. An assembly of semiconductor phosphor nanoparticles obtained by a method of producing an assembly of semiconductor phosphor nanoparticles, as claimed in claim 1.

4. The assembly of semiconductor phosphor nanoparticles as claimed in claim 3, wherein an average particle size of the semiconductor phosphor nanoparticles is from 1 to 10 nm.

5. The assembly of semiconductor phosphor nanoparticles as claimed in claim 3, wherein the semiconductor phosphor nanoparticles comprise Si or Ge.

6. A single molecule observation method comprising:
exposing a molecule labeled with a semiconductor nanoparticle phosphor constituting an assembly of semiconductor phosphor nanoparticles as claimed in claim 3 to exciting light, and
detecting an emitted light to perform identification of the molecule.

7. The single molecule observation method as claimed in claim 6, wherein the method comprises labeling plural kinds of molecules with semiconductor nanoparticle phosphors exhibiting different emission spectra, and exposing the molecules to exciting light to perform simultaneous identification of plural kinds of substances.

8. An assembly of semiconductor phosphor nanoparticles obtained by a method of producing an assembly of semiconductor phosphor nanoparticles, as claimed in claim 2.

9. The assembly of semiconductor phosphor nanoparticles as claimed in claim 8, wherein an average particle size of the semiconductor phosphor nanoparticles is from 1 to 10 nm.

10. The assembly of semiconductor phosphor nanoparticles as claimed in claim 8, wherein the semiconductor phosphor nanoparticles comprise Si or Ge.

11. A single molecule observation method comprising:
exposing a molecule labeled with a semiconductor nanoparticle phosphor constituting an assembly of semiconductor phosphor nanoparticles as claimed in claim 8 to exciting light, and
detecting an emitted light to perform identification of the molecule.

12. The single molecule observation method as claimed in claim 11, wherein the method comprises labeling plural kinds of molecules with semiconductor nanoparticle phosphors exhibiting different emission spectra, and exposing the molecules to exciting light to perform simultaneous identification of plural kinds of substances.
